(19) United States
(12) Patent Application Publication
(10) Pub. No.: US 2024/0419971 A1
(43) Pub. Date: Dec. 19, 2024

(54) CONTROLLING SIGNAL STRENGTHS IN ANALOG, IN-MEMORY COMPUTE UNITS HAVING CROSSBAR ARRAY STRUCTURES

(71) Applicant: International Business Machines Corporation, Armonk, NY (US)

(72) Inventors: Julian Röttger Büchel, Zurich (CH); Manuel Le Gallo-Bourdeau, Horgen (CH); Abu Sebastian, Adliswil (CH)

(21) Appl. No.: 18/333,966

(22) Filed: Jun. 13, 2023

(51) Int. Cl. G06N 3/084

(52) U.S. Cl. CPC G06N 3/084

(57) ABSTRACT

Precision of a neural processing apparatus comprising two in-memory compute (IMC) units is controlled, wherein the IMC units include a first IMC unit and a second IMC unit, each designed to perform vector-matrix multiplication (VMM) to produce analog output signals. An artificial neural network (ANN) model is trained to learn its parameters (including synaptic weight values) in accordance with a dual objective. The ANN model comprises two neural layers, these including a first neural layer and a second neural layer. The method further comprises storing the synaptic weight values of the parameters learned in the two IMC units to respectively map the first neural layer and the second neural layer onto the first IMC unit and the second IMC unit. The second IMC unit is designed to perform VMM operations based on analog input signals generated from activation values produced by the first neural layer.

### BACKGROUND

The present disclosure relates generally to in-memory and near-memory processing techniques and related acceleration techniques, relying on neural processing apparatuses equipped with in-memory compute units having a crossbar array structure. In particular, it relates to methods and systems for increasing the precision of a neural processing apparatuses.

Machine learning often relies on artificial neural networks (ANNs), which are computational models inspired by neural networks in biological brains. Such systems progressively and autonomously learn tasks by means of examples. They have been successfully applied to a number of tasks, such as speech recognition, text processing, and computer vision.

An ANN includes a set of connected units (or nodes), which compare to biological neurons; they are accordingly called artificial neurons (or simply neurons). Signals are transmitted along connections (also called edges) between the artificial neurons, similarly to synapses. I.e., an artificial neuron that receives a signal, processes it, and then signals connected neurons. Signaling operations refer to signals conveyed along such connections. The signals typically encode real numbers. The outputs of the artificial neurons are usually computed thanks to a non-linear function of the sum of its inputs.

Connection weights (also called synaptic weights) are associated with the connections between nodes. Each neuron may have several inputs and a connection weight is attributed to each input (i.e., the weight associated with the corresponding connection). Such weights are learned during a training phase. The learning process can for instance be iteratively performed, in a supervised fashion. In other words, data examples are presented to the network in the form of input-output pairs, typically one at a time, and the weights associated with the input values are adjusted at each time step, for the network to learn to reproduce the outputs of the pairs based on the presented inputs. In ANNs performing classification tasks, the output typically consists of a label representing the class to be predicted by the network.

Various types of neural networks are known, starting with feedforward neural networks, such as multilayer perceptrons, deep neural networks, and convolutional neural networks. Neural networks are typically implemented in software. However, a neural network may also be implemented in hardware, e.g., as an optical neuromorphic system, a system relying on resistive processing units (relying, e.g., on memristive crossbar array structures), or other types of neuromorphic circuits. Hardware-implemented neural networks are physical machines that differ from conventional computers in that they are primarily and specifically designed to execute neural network operations. Often, such hardware is meant for inferencing purposes, while the training of the underlying computational models is performed using conventional hardware or software.

Matrix operations are frequently needed in several applications, such as technical computing applications and, in particular, cognitive tasks. Matrix operations notably include matrix-matrix multiplications (MMMs), matrix-vector multiplications (MVMs), and vector-matrix multiplications (VMMs), which are often jointly referred to as matrix-vector multiplications (MVMs). Examples of such cognitive tasks are the training of, and inferences performed with, cognitive models such as neural networks for computer vision and natural language processing, and other machine learning models such as those used for weather forecasting and financial predictions.

MVM operations pose multiple challenges, because of their recurrence, universality, matrix size, and memory requirements. On the one hand, there is a need to accelerate these operations, notably in high-performance computing applications. On the other hand, there is a need to achieve an energy-efficient way of performing them.

Traditional computer architectures are based on the von Neumann computing concept, where processing capability and data storage are split into separate physical units. Such architectures suffer from congestion and high-power consumption, as data must be continuously transferred from the memory units to the control and arithmetic units through physically constrained and costly interfaces.

One possibility to accelerate MVMs is to use dedicated hardware acceleration devices, such as dedicated circuits having a crossbar array configuration. This type of circuit includes input lines and output lines, which are interconnected at cross-points defining cells. The cells contain respective memory devices (or sets of memory devices), which are designed to store respective matrix coefficients. Vectors are encoded as signals applied to the input lines of the crossbar array to perform multiply-accumulate (MAC) operations. There are several possible implementations. For example, the coefficients of the matrix (“weights”) can be stored in columns of cells. Next to every column of cells is a column of arithmetic units that can multiply the weights with input vector values (creating partial products) and finally accumulate all partial products to produce the outcome of a full dot-product. Such an architecture can simply and efficiently map a matrix-vector multiplication. The weights can be updated by reprogramming the memory elements, as needed to perform matrix-vector multiplications. Such an approach breaks the “memory wall” as it fuses the arithmetic- and memory unit into a single in-memory-computing (IMC) unit, whereby processing is done much more efficiently in or near the memory (i.e., the crossbar array).

What is more, using analog memory devices in an IMC unit allows MVM operations to be efficiently performed, by exploiting analog storage capability of the IMC device and Kirchhoff's circuits laws. Another advantage of crossbar array structures is that they support transposed matrix operations, something that can be exploited to train ANNs. More generally, the key compute primitive enabled by such devices can also be used for other applications, e.g., solvers for systems of linear equations.

However, a key challenge is to achieve a satisfactory computational accuracy, which is notably determined by the accuracy with which target synaptic conductance values can be mapped onto the synaptic elements, i.e., the analog memory elements. Now, they are other potential sources of computational inaccuracy.

### SUMMARY

According to a first aspect, a method of controlling a precision of a neural processing apparatus comprising two in-memory compute (IMC) units is provided, wherein the IMC units include a first IMC unit and a second IMC unit, each designed to perform vector-matrix multiplication (VMM) operations, to produce analog output signals. The method includes training an artificial neural network (ANN) model for the model to learn its parameters (including synaptic weight values) in accordance with a dual objective. The ANN model includes two neural layers, these including a first neural layer and a second neural layer. The method further includes storing the synaptic weight values of the parameters learned in the two IMC units to respectively map the first neural layer and the second neural layer onto the first IMC unit and the second IMC unit. The second IMC unit is designed to perform VMM operations based on analog input signals generated from activation values produced by the first neural layer. The dual objective includes a primary optimization objective and an auxiliary objective. The primary optimization objective is a conventional objective for the ANN model, such as a training accuracy objective, whereas the auxiliary objective enforces a target distribution property, or even a target distribution, on activation values produced by the first neural layer.

According to another aspect, an information processing system is provided. The system includes one or more processing devices configured to train an ANN model for the model to learn its parameters in accordance with a dual objective. The ANN model includes two neural layers, these including a first neural layer and a second neural layer. The parameters include synaptic weight values. Consistently with the above method, the dual objective includes a primary optimization objective for training the ANN model and an auxiliary objective enforcing a target distribution property on activation values produced by the first neural layer. The neural processing apparatus includes two IMC units, these including a first IMC unit and a second IMC unit. Each of the IMC units is designed to perform VMM operations to produce analog output signals. The second IMC unit is designed to perform VMM operations based on analog input signals generated from activation values produced by the first neural layer, in operation. The processing devices are operatively connected to the neural processing apparatus to cause to store the synaptic weight values in the two IMC units to respectively map the first neural layer and the second neural layer onto the first IMC unit and the second IMC unit, in operation.

According to another aspect, a computer program product for controlling a precision of a neural processing apparatus is provided comprising two analog IMC units, these including a first IMC unit and a second IMC unit. The computer program product comprises a computer readable storage medium having program instructions embodied therewith. The program instructions are executable by one or more processing devices connected to the neural processing apparatus to cause the processing devices to train an ANN model, for the model to learn its parameters in accordance with a dual objective, as explained above. In addition, the program instructions cause to instruct to store the synaptic weight values of the parameters learned in the two IMC units to respectively map the first neural layer and the second neural layer onto the first IMC unit and the second IMC unit.

### BRIEF DESCRIPTION OF THE DRAWINGS

These and other objects, features and advantages of the present disclosure will become apparent from the following detailed description of illustrative embodiments thereof, which is to be read in connection with the accompanying drawings. The illustrations are for clarity in facilitating one skilled in the art in understanding the present disclosure in conjunction with the detailed description. In the drawings:

FIG. 1 schematically represents a computerized system, in which a user interacts with a server, via a personal computer, in order to train a neural network model and then offload the execution of the trained network to a neural processing apparatus involving in-memory compute (IMC) units, which are cascaded, as in embodiments of the present disclosure;

FIG. 2 schematically illustrates the architecture of an analog IMC unit having a crossbar array structure, as involved in embodiments;

FIG. 3 depicts successive distributions of values obtained by executing a neural network on a neural processing apparatus that is not optimized for precision yet. The distributions are depicted as histograms. They include (from top to bottom): a distribution of full-precision activation values as obtained from a given layer of the neural network model, implemented by a given IMC unit; a distribution of such activation values after conversion to INT8 values, with a view to generating analog input signals; and a distribution of output values as obtained by a further IMC unit, which is connected by the given IMC unit, by performing vector-matrix multiplications based on input signals obtained based on activation values from the previous layer;

FIG. 4 depicts successive distributions of values, similar to those of FIG. 3, albeit obtained by executing the neural network on a neural processing apparatus using synaptic weights that were optimized according to a dual objective, to enforce a target distribution on activation values produced by said given neural layer, as in embodiments. Doing so widens the distributions, which results in stronger signals and, eventually, increases the precision and performance of the system;

FIG. 5 is a flowchart illustrating high-level steps of a method of controlling a precision of a neural processing apparatus, according to embodiments;

FIG. 6 is another flowchart, illustrating how a target distribution can be enforced on activation values produced by a neural layer, as in embodiments; and

FIG. 7 represents a general-purpose computerized system, which can be used to train the ANN model according to a dual objective, as in embodiments of the present disclosure.

The accompanying drawings show simplified representations of devices or parts thereof, as involved in embodiments. Similar or functionally similar elements in the figures have been allocated the same numeral references, unless otherwise indicated.

Computerized systems, methods, and computer program products embodying the present disclosure will now be described, by way of non-limiting examples.

### DETAILED DESCRIPTION

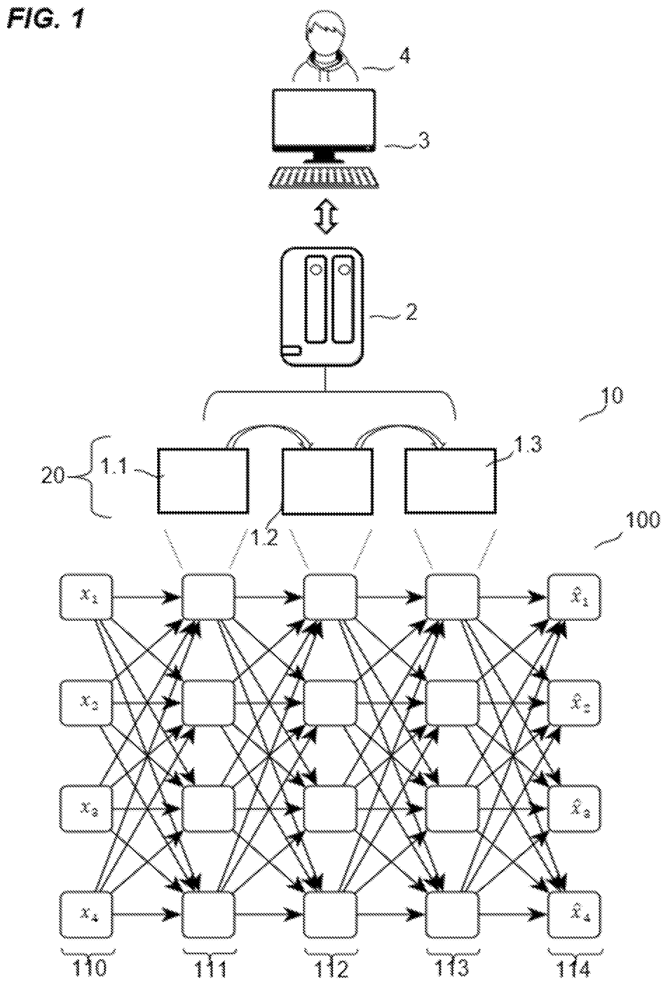

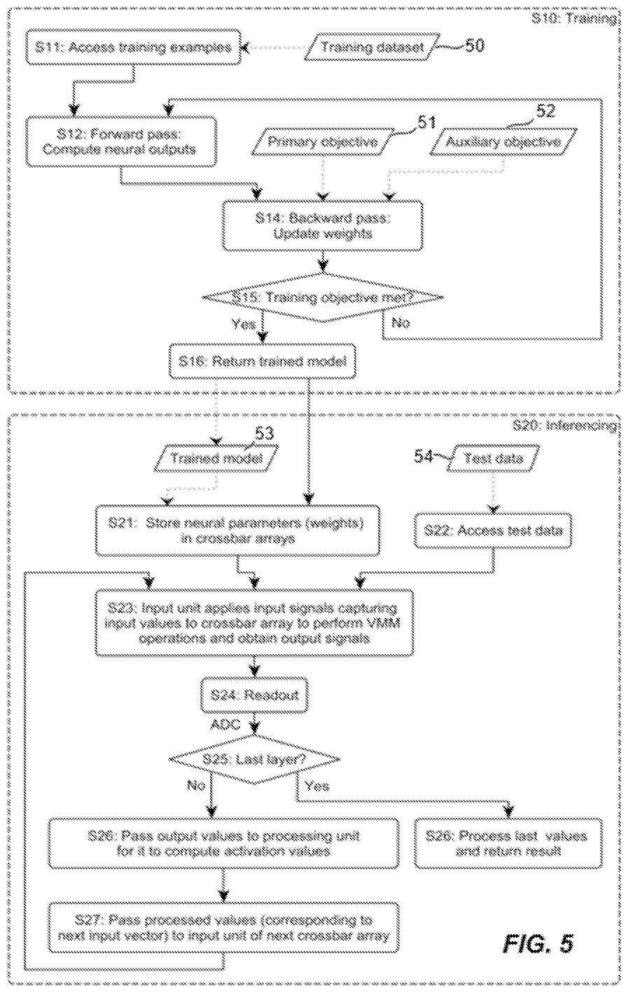

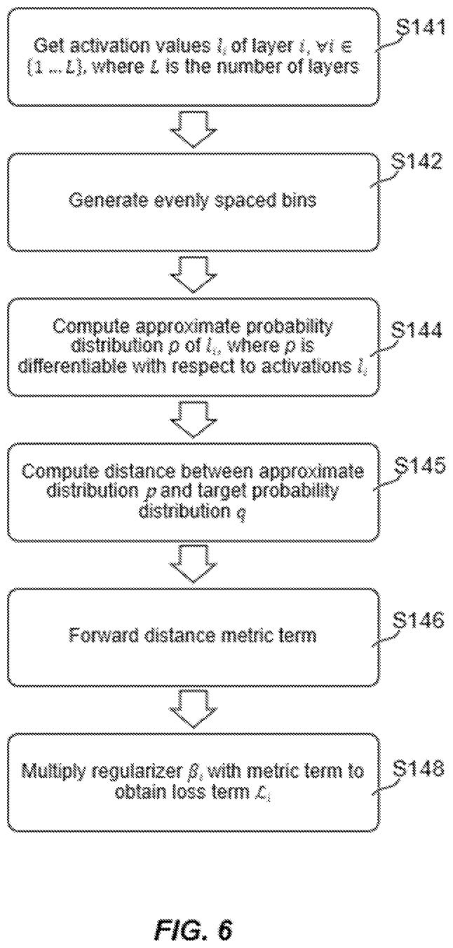

A first aspect of the present disclosure is now described in reference to FIGS. 1, 2, and 5. This aspect concerns a method of controlling a precision of a neural processing apparatus 20. Note, this method and its variants are sometimes collectively referred to as the “present methods” in this document. All references Sn refer to methods steps of the flowcharts of FIGS. 5 and 6, while numeral references pertain to devices, components, and concepts, as involved in embodiments of the present disclosure.

As seen in FIG. 1, the neural processing apparatus 20 comprises at least two in-memory compute (IMC) units 1. In particular, the IMC units 1 may include a first IMC unit 1.1 and a second IMC unit 1.2. Each IMC unit is designed to perform analog vector-matrix multiplication (VMM) operations and produce analog output signals as a result of the VMM operations. The IMC units 1 and the neural processing apparatus 20 are described later in detail, in reference to another aspect of the present disclosure.

The method comprises training an artificial neural network (ANN) model 100, this corresponding to general step S10 in the flow of FIG. 5. The ANN model 100 comprises at least two neural layers 111-113 (also referred to as “ANN layers” or, simply, “layers”, in this document), these including a first neural layer 111 and a second neural layer 112, see FIG. 1. As usual, the ANN model is trained S10 for the model to learn S14 its own parameters, also called neural parameters. Such parameters may include, or possibly consist of, synaptic weight values, also referred to as “weights” in this document, for simplicity. In the present context, though, the ANN model is trained in accordance with a dual objective, a concept that is discussed in detail below.

The method further comprises storing the synaptic weight values of the parameters learned in the two IMC units 1, something that can be performed right after the completion of the training step S10, see step S21 in FIG. 5. The aim is to ready the IMC units 1 for subsequent inferences to be performed by the neural processing apparatus 20. The synaptic weight values are stored in the IMC units 1 to map the neural layers of the ANN model onto respective IMC units 1. In particular, the first neural layer 111 and the second neural layer 112 are respectively mapped onto the first IMC unit 1.1 and the second IMC unit 1.2. Beyond synaptic weight values, additional parameter values may possibly be stored in the IMC units, such as biases, if necessary. Once the weights are stored in the IMC units, the neural processing apparatus 20 is ready to perform inferences.

The IMC units 1 are cascaded, to reflect the layer structure of the ANN 100. On execution of the ANN model, each IMC unit produces output signals, which are converted to digital values to produce output values. The latter are subject to some processing to generate activation values. I.e., activation values are computed thanks to an activation function. As activation values produced by each ANN layer are obtained in the digital domain, they need to be converted to analog signals to enable analog VMM operations to be performed S23 by the next layer, i.e., by an analog IMC unit. In turn, this analog IMC unit performs analog VMM operations based on input signals injected into this unit. In particular, the second IMC unit 1.2 is designed to perform VMM operations based on analog input signals generated from activation values produced by the first neural layer 111.

Optimization, in the present context, may be achieved using a dual objective. The dual objective includes both a primary optimization objective 51 and an auxiliary objective 52. The primary optimization objective 51 is the usual training objective for the ANN model 100, e.g., an objective in terms of training accuracy or, more generally, task performance. The primary optimization objective is captured by an objective function (e.g., a loss function or a reward function), which is optimized, as part of the optimization performed in accordance with the dual objective. Depending on how it is defined, the objective function may have to be minimized, maximized, or otherwise optimized, in respect of part or all of the training dataset. However, in the present context, the optimization procedure may result in a trade-off, because of the auxiliary objective 52, which forms part of the dual objective too. Namely, the auxiliary objective 52 is devised so as to enforce a target distribution property on activation values produced by the first neural layer 111 or, more generally, on activation values produced by any ANN layer that one wishes to optimize for precision. In other words, the ANN is optimized with respect to the primary optimization objective 51, subject to the auxiliary objective.

This dual objective can normally be formulated thanks to two respective, objective functions. Such functions may possibly be iteratively optimized, e.g., thanks to an iterative optimization procedure, which alternately optimizes against the primary optimization objective 51 and the auxiliary objective 52. A preferred variant, however, is to implement a regularization in the loss function to add a penalty depending on a distance between the activation distribution and a target distribution, as in embodiments discussed later.

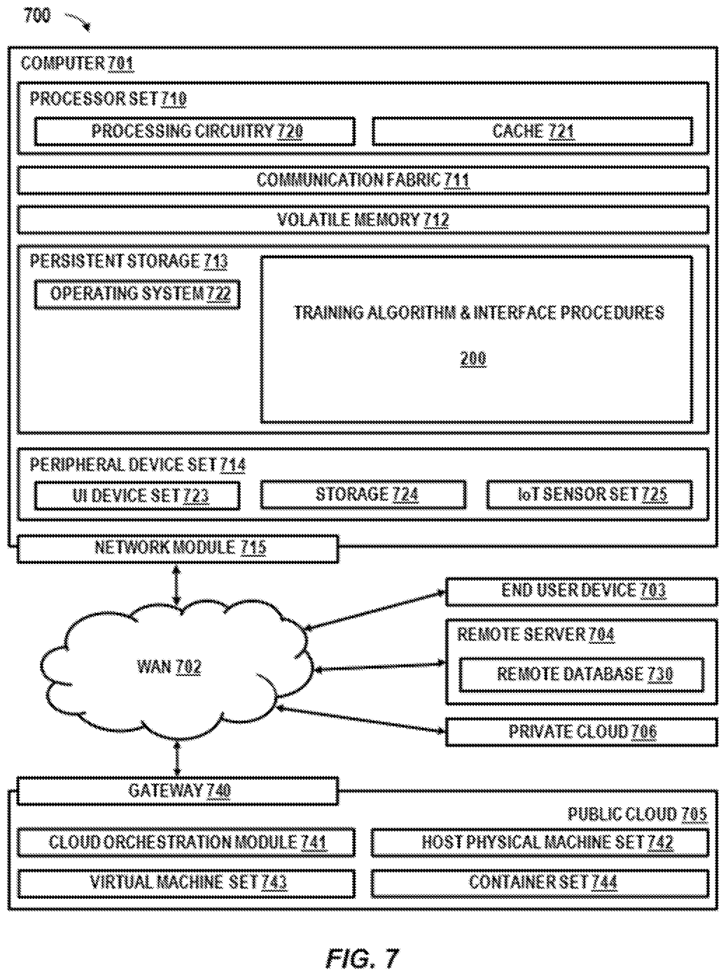

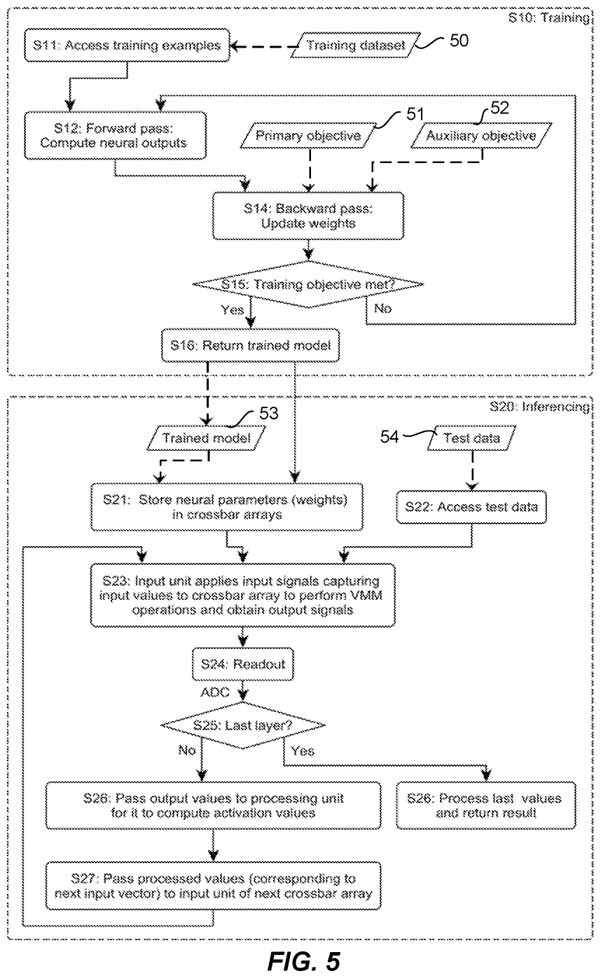

The training is preferably performed outside of the neural processing apparatus 20, i.e., on a distinct computer 2, 3, which can be a conventional computer 701 such as shown in FIG. 7. The training is typically performed based on a training dataset that includes training examples. In a supervised setting, each training example (also called “example”, “sample”, or “training sample”) is eventually processed as an input-output pair of the form {input data label}, even though the training data may initially not explicitly associate pairs of such elements. In that case, it is required to specify which labels are to be used for training purposes. In principle, though, the present approach extends to unsupervised settings too. For example, the training algorithm may cause the model to learn to predict masked-out portions of an image. After the training, the trained model may be evaluated against a validation dataset, if necessary.

By definition, the auxiliary objective 52 acts in a subsidiary capacity; the primary objective remains the principal objective to be achieved in order to meaningfully train the network. This hierarchical relationship between the two objectives can be enforced by merely weighting the contributions capturing the two objectives. That is, the auxiliary objective can be downplayed thanks to, e.g., a scalar, which is adjusted to give slightly less weight to the auxiliary objective 52. As a result, training the ANN model 100 causes the activation values to conform to the desired target distribution property, but only to an extent permitted by the primary optimization objective 51 for the ANN model.

The target distribution property may notably be devised so that enforcing this property causes to increase an information entropy of the distribution of the activation values (as produced by any layer of interest) across a range of values spanned by the activation values, in comparison with the distribution that would be obtained in absence of the auxiliary objective. In practice, the produced activation values can be re-arranged as a histogram with equal bin widths, where the histogram approximates the underlying (smooth) distribution of the corresponding values. This, in turn, makes it possible to compute an information entropy (e.g., a base k information entropy) of the values according to the probability πⱼ for such values to belong to the j^{th} bin of the N_{b} bins. I.e., the entropy is computed as Σⱼ₌₁^{N}^{_{b}}πⱼ logₖ(πⱼ), where the base k chosen for the logarithm function is typically equal to 2 (k=2). Use is made, in the following, of the shorthand notation log≡logₖ.

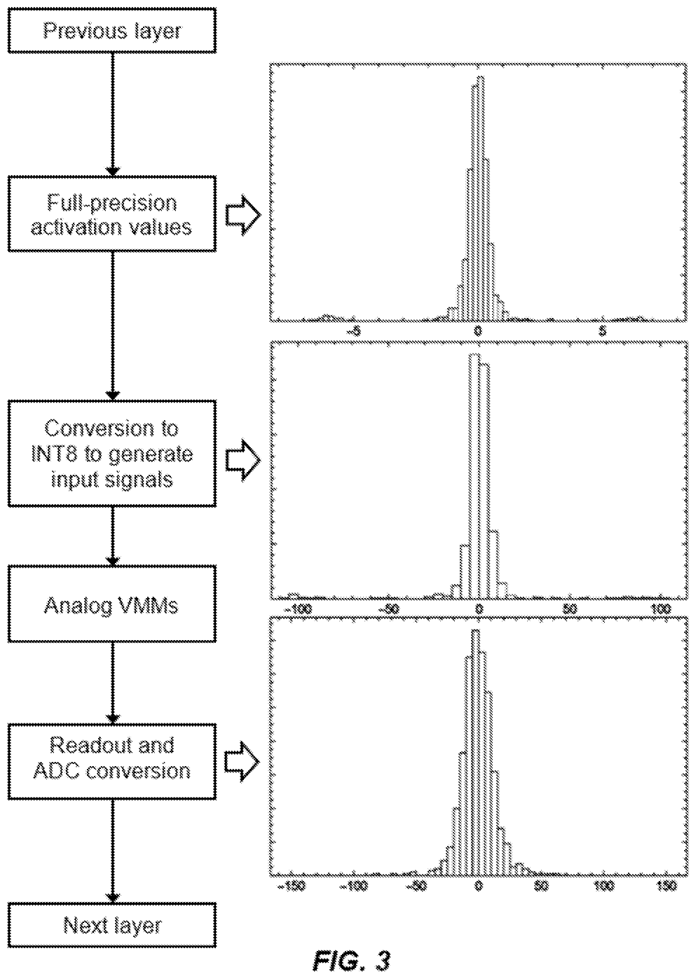

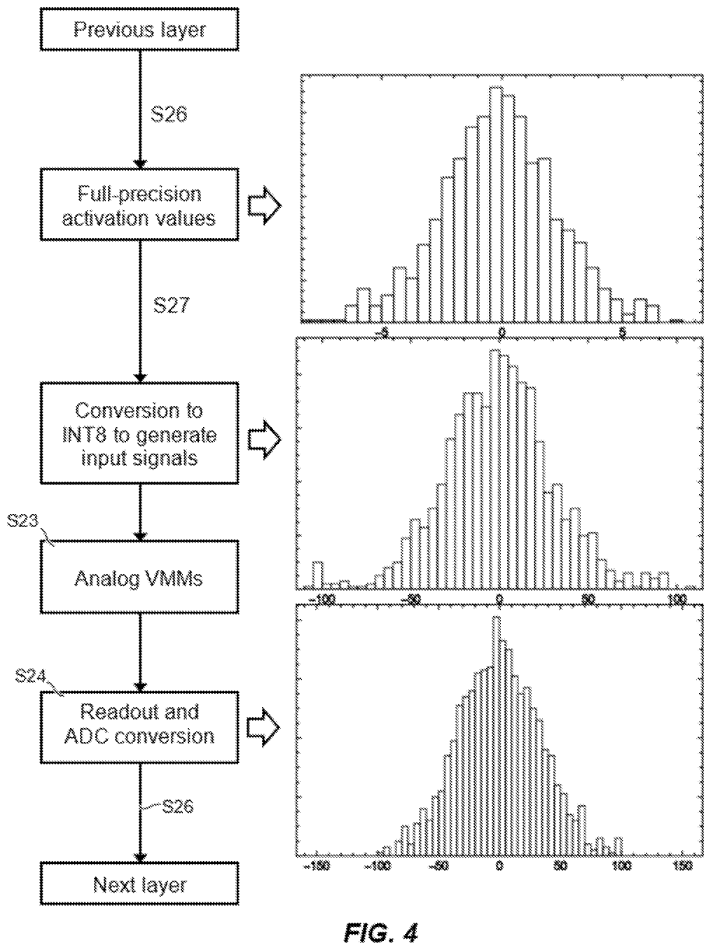

In practice, that the target distribution property increases the information entropy of the distribution of the activation values amounts to widening such a distribution, i.e., to increasing the standard deviation of the distribution. This can be visualized by comparing the distributions depicted in FIGS. 3 and 4.

A convenient way to enforce the target distribution property is to enforce a target distribution on the set of activation values. I.e., on training the ANN, the target distribution urges a distribution of the set of activation values to span a range of values in accordance with said distribution property. Increasing the information entropy can for instance be achieved by attempting to enforce a uniform distribution. This means that, in absence of the primary objective, the distribution of the activation values would readily be forced to conform to a uniform distribution, something that would maximize the information entropy of the activation values. However, this uniform distribution will likely not be reached, in practice, because of the primary objective. Rather, enforcing the uniform distribution will result in increasing the entropy. Note, the uniform distribution can be implicitly enforced, should the distance be computed by means of an information entropy, as in embodiments discussed later.

In variants, other distributions can be used as part of the auxiliary objective, such as a normal distribution, having a certain standard deviation, or a skew normal distribution, having a non-zero skewness. More generally, the optimization procedure may try to enforce certain properties, e.g., in terms of standard deviations, skewness, and/or kurtosis. In general, though, the target probability distribution (property) may be devised so as to widen the distribution of activation values produced by the neural layer(s). I.e., the enforced property affects how the activation values distribute across the range of values. In particular, the target distribution (property) urges the actual distribution of the set of activation values produced by the first neural layer 111 to span a range of values in a certain manner.

The training finds a trade-off between the primary optimization objective 51 and the second objective 52. In practice, most of the activation and output distributions are already Gaussian. In general, one tries to achieve bell-shaped distributions that have larger standard deviations, i.e., to widen such distributions, compared to distributions that would be obtained based on the sole primary optimization objective 51. The result is a widened, bell-shape distribution, as seen by comparing FIGS. 3 and 4. This widening amounts to increasing the information entropy.

The above scheme extends to any number of neural layers and corresponding IMC units 1, although it may also target specific layers of the ANN 100, even a single neural layer. In that case, activation values produced by the optimized layer are fed as input to the next layer. Still, as each layer are mapped onto a respective IMC unit 1, it remains that at least two IMC units are involved in that case too. When applying the above scheme to L layers (i.e., the ANN model comprises L neural layers, where L>2), the neural processing apparatus 20 comprises L IMC units 1, which are cascaded. I.e., they form a chain. The synaptic weight values of the parameters learned are stored across the L IMC units 1, so as to effectively map the L neural layers onto the L IMC units. In that case, the auxiliary objective 52 enforces target distribution properties on L−1 sets of activation values respectively produced by the first L−1 layers, so as for the last L−1 IMC units 1 of the chain to perform VMM operations based on L−1 sets of analog input signals generated from the L−1 sets of activation values obtained from the first L−1 neural layers, respectively. That is, the second IMC unit performs VMM operations based on a set of analog input signals generated from the set of activation values obtained from the first neural layer, the third IMC unit performs VMM operations based on a set of analog input signals generated from the set of activation values obtained from the second neural layer, and so on.

As per the cascaded arrangement, constraining the distribution of activation values obtained from any layer n−1 makes it possible to control, to a certain extent, the distribution of the output signals produced by the IMC unit n, for all n equal to 2 to L. That is, the distribution of activation values from layer n−1 impacts on the distribution of the output signals produced by the IMC unit n, something that can be leveraged to impose certain properties to the output signals of IMC unit n. This, in turn, makes it possible to act on the signal-to-noise ratio and, thus, on the signal strengths. In particular, stronger signals result in increasing the signal-to-noise ratio, which benefit the precision of subsequent VMM operations. In turn, this improves the performance of inferences performed by the IMC units 1, notably in terms of accuracy. For example, widening the distribution of the output signals results in signal intensities that are better distributed around the zero value, corresponding to the zero-intensity signal (compare FIGS. 3 and 4). And this, in turn, results in stronger average signals, hence a lower signal-to-noise ratio.

In other words, by suitably constraining the distribution of activation values obtained from a given neural layer, thanks to an auxiliary objective as described above, stronger output signals can be produced by the IMC units 1 upon inferencing. In turn, such signals are converted to obtain more precise activation values, leading to further input signals injected in the next IMC unit (corresponding to the next layer), and so on. All in all, the proposed method can be used to improve the precision of the neural processing apparatus 20 and, in turn, the accuracy of the results produced by the apparatus 20 upon inferencing.

Preferred embodiments of the method attempt to enforce a target distribution, rather than a mere target distribution property, for practical reasons. In particular, the auxiliary objective 52 may be devised so as to minimize, during the training phase, a distance between the distribution of the activation values and the target distribution, albeit to an extent permitted by the primary optimization objective 51, in accordance with the dual objective. This distance can be measured thanks to any suitable “metric”. Here, a distance metric is to be understood in a broad sense. The distance metric used does not necessarily need to be a true distance metric. In addition, this distance may equivalently be formulated as a similarity, which would then have to be maximized. In particular, one may use any metric that suitably captures a similarity of the compared distributions, as well as other metrics such as the Kullback-Leibler (KL) divergence, which are not true distance metrics.

In principle, the dual objective can be captured by an objective function that can be formulated as a loss function or a reward function. One may for instance capture the dual objective as a dual loss function, which can be decomposed as a sum of two contributions, i.e., a first contribution reflecting the primary objective 51 and a second contribution reflecting the auxiliary objective 52. More generally, if L layers are to be optimized, the dual loss function can be written as [symbol] = [symbol] _{P}+Σᵢ₌₁^{L} βᵢ [symbol] ᵢ, where [symbol] _{P} denotes the first contribution (reflecting the primary objective), [symbol] ᵢ corresponds to a contribution pertaining to layer i, L being the total number of layers, and the coefficients βᵢ are provided to adjust the strengths of the auxiliary contributions [symbol] ᵢ. The sign of the coefficients βᵢ depends on whether the auxiliary functions [symbol] ᵢ are to be maximized or minimized. In principle, distinct target distributions may be contemplated for each layer. In the following, though, we assume a same target distribution for each layer.

As evoked above, the second contribution may for instance depend on the distance between the distribution of the set of activation values (for layer i) and the target distribution (for that layer). In that case, the optimization procedure seeks to minimize the global loss function. In variants to loss functions, however, the objective function may also be formulated as a reward function, also called a profit function, utility function, fitness function, etc.

In principle, the two contributions to the dual objective functions must be jointly optimized. This can notably be achieved by iteratively optimizing the two objective functions, thanks to known iterative optimization procedures. Such iterations would typically be nested in the training iterations. In practice, however, the second contribution can more conveniently be implemented by a regularizer. The regularizer is added to the loss function reflecting the sole first contribution. That is, a regularization term is added to the loss function (first contribution) to add a penalty to the first contribution, where the penalty depends on the distance defined above.

The ANN model 100 is typically trained S12-S15 iteratively, as seen in the flow of FIG. 5, whereby forward and backward passes are iteratively performed. As usual, the forward pass causes, at each iteration, to estimate outputs of the ANN model, as in its current state (not optimized yet). I.e., each layer produces outputs, causing the ANN to produce overall outputs, which are then used to estimate the current loss. For example, as seen in FIG. 1, the input layer 110 contains inputs xₜ, which are injected into the first layer 111. The latter produces outputs, which are fed into layer 112. The same procedure repeats over layers 112, 113, to final reach layer 114, i.e., the output layer, which produces the last output values \hat{x}ₜ. Note, the output layer is assumed to have the same dimensionality as the input layer 110 and the hidden layers 111-113 in this simple example. Obviously, this is not necessarily the case in practice. Plus, the dimensionality of layers 110-113 is purposely kept small in this example, for the sake of depiction.

After each forward pass S12, a current distribution of the set of activation values produced by each layer i can advantageously be approximated S141-S144 by a kernel density function, see FIG. 6. This makes it possible to measure S145 said distance as a distance between the approximated probability distribution (as obtained through the kernel density estimation) and the target distribution. In turn, the ANN parameters can be updated S14 with a view to decreasing the loss function, this also causing to decrease said distance. Note, steps S141-148 (FIG. 6) are assumed to be all performed during the backward pass S14, for simplicity. However, some of these steps can be started before completing the forward pass. Different implementations can be contemplated, where at least some of these steps may be started as soon as forward computations for one layer complete. All steps S141-S148 need to be completed before updating the neural parameters.

As usual, the primary loss is devised so as to be differentiable with respect to the neural parameters. Interestingly, here, the kernel density function too can be devised so as to be differentiable, albeit with respect to variables corresponding activation values. Yet, as a result of the chain rule for derivatives, the distance between the kernel density function and the target distribution is differentiable with respect to the ANN parameters. Thus, the ANN model 100 can be trained in accordance with the backpropagation algorithm, using partial derivatives of the global loss function with respect to the neural parameters. The backpropagation algorithm causes to update S14 the weights for them to produce activation values that will better conform to the target distribution during the next forward pass. Note, the backpropagation algorithm implies that the underlying ANN is a feedforward artificial neural network. However, variants to the backpropagation algorithm are known, which allow other network architectures to be trained.

In more detail, in order to determine the gradient of the dual loss function with respect to every weight, one also has to be able to compute the gradient of the loss with respect to the activation values. This is usually trivial since the weights directly produce the activation values. But if there is a non-differentiable operation acting on the activation values, as is the case here, it is a priori not possible to compute the gradient of the loss with respect to the activation values. Now, all operations involved in the computational graph (also the kernel density estimation S144) should ideally be differentiable, to case the optimization algorithm (e.g., based on a gradient descent).

To illustrate this, assume that a histogram is generated from the activation values to approximate the activation distribution. The approximate and target distributions are denoted by p and q, respectively. The distance between the two distributions, which can be noted d (q, p), is a priori not differentiable with respect to the activation values since a histogram is not differentiable as such. Still, gradients are needed in order to reach optimal weights. Otherwise, adding a distance to the loss function has no effect. Thus, the kernel density function too is advantageously made differentiable. In variants, however, derivative-free optimizers can be contemplated too.

As further seen in FIG. 6, the training S10 of the ANN model 100 may comprise generating bins, e.g., evenly spaced bins, spanning the range of activation values and, this for each layer i. That is, the bins extend from the minimum value up to the maximum value of the activation values. The aim is to measure the distance thanks to a distance function, where the distance is evaluated as a sum of values taken by the distance function over the bins.

The distance may for instance be measured as a KL divergence between the kernel density function and the target distribution. The KL divergence is computed as an expected value of a logarithm of a ratio of the kernel density function to the target distribution, where the logarithm is averaged in accordance with the kernel density function computed over the bins. Note, the KL distance is not a true distance metric. First, it is not symmetric in the compared distributions, although it could easily be symmetrized. Second, it does not satisfy the triangle inequality. This, however, is of little importance here, as long as the distance computed tells something relevant as to how far the actual distribution (estimated) is from the target distribution.

A possible scheme is shown in FIG. 6. At step S141, the algorithm fetches activation values lᵢ of layer i, ∀i∈{1 . . . . L}, where L is the number of layers considered. It generates evenly spaced bins at step S142. At step S144, it computes an approximate probability distribution p(xⱼ) of the activation values lᵢ, where this approximate function is differentiable with respect to activation values lᵢ. The distance between the approximate distribution p and the target probability distribution q is then computed at step S145, e.g., as a KL divergence or an entropy (as exemplified later). Next, the distance metric term obtained is passed S146 to the loss estimator for it to multiply a regularizer term βᵢ (for each layer i) with the metric term, so as to obtain the i^{th} contribution [symbol] ᵢ (i.e., referred to as the second contribution earlier).

For example, the dynamic range d of an activation vector can be calculated as d=max (lᵢ)−min (lᵢ), where lᵢ denotes layer activation values (vector) of the i^{th} layer. This, in turn allows the value h=\tilde{h}×d to be computed, where h is the kernel width adjusted to the dynamic range of the activation vector lᵢ and \tilde{h} is the width of the kernel. Besides, one may compute x=bins (min(lᵢ), max(lᵢ), N_{B}), where x is the vector holding the bins, the functions “min” and “max” compute the minimum value and the maximum value of the vector passed, and the function “bins” is the function generating N_{B} evenly spaced bins between the first and second arguments of this function. Then, the method may compute \tilde{p}(xⱼ)=Σₖ₌₁^{N}^{ₗ} Kₕ(xⱼ−lᵢₖ), where Kₕ is the kernel function with parameter h. For example, \tilde{p}(xⱼ) can be computed as

$$\tilde{p} ( {x}_{j} ) = {\sum }_{k = 1}^{{N}_{l}} \frac{1}{2 π {h}^{2}} exp ( - {( {x}_{j} - {l}_{{i}_{k}} )}^{2} / 2 {h}^{2} ) ,$$

for each layer i. I.e., the kernel density estimator Kₕ is a gaussian in that case.

The kernel function takes xⱼ−lᵢ_{ₖ} as argument, where lᵢ_{ₖ} is the k^{th} element of the vector lᵢ. The function \tilde{p} is the sum of the kernel functions as estimated for k=1 to Nₗ, where Nₗ is the number of elements in the activation vector lᵢ. In other words, the kernel density estimator Kₕ takes each individual value and draws a small gaussian bell curve over it. Normalizing \tilde{p}(xⱼ) as p(xⱼ)=\tilde{p}(xⱼ)/Σᵣ₌₁^{N}^{_{B}}\tilde{p}(xᵣ) provides p(xⱼ), the approximate distribution as evaluated at the value xⱼ, corresponding to the j^{th} element of vector x. In turn, one may evaluate the KL divergence of layer i as KLᵢ(p, q)=Σⱼ₌₁^{N}^{ₗ}p(xⱼ)log(p(xⱼ)/q(xⱼ)+ϵ), where q is the target distribution to be enforced and ϵ is a constant provided to ensure numerical stability (e.g., ϵ=10⁻⁶). The KL divergence can similarly be computed for each layer i, which makes it finally possible to compute the global loss as [symbol] = [symbol] _{P}+Σᵢ₌₁^{L}βᵢ KLᵢ, where L is the total number of layers and βᵢ is a regularization parameter that can be tuned to adjust the auxiliary contributions.

In variants, the distance is measured as an information entropy of the kernel density function. The information entropy is computed as an expected value of the logarithm of the kernel density function computed over said bins. Note that this is mathematically equivalent to attempting to impose the uniform distribution as a target distribution. However, using the information entropy makes computations easier. In that case, the computation flow is similar to the previous flow, except that the distance is now computed as H (lᵢ)=−Σⱼ₌₁^{N}^{_{B}} p(xⱼ)log(p(xⱼ)+ϵ), where H(lᵢ) is the entropy of the activation values of layer i, whereby the loss becomes [symbol] = [symbol] _{P}+Σᵢ₌₁^{L} βᵢ H (lᵢ).

In principle, we want to maximize the entropy; a higher entropy meaning a wider distribution. So, in the above example, given that the loss [symbol] = [symbol] _{P}+Σᵢ₌₁^{L} βᵢ H (lᵢ) must, as a whole, be minimized, the coefficients βᵢ must be set to negative values, in order to effectively minimize the loss by increasing the entropy. On the contrary, in the previous example (based on the KL divergence), the coefficients βᵢ are set to positive values.

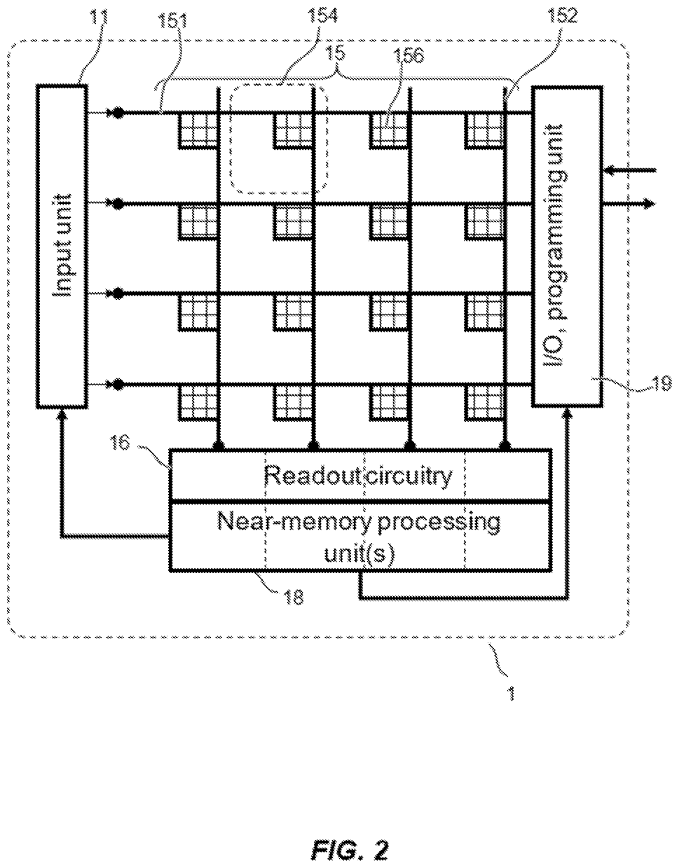

The training S10 gradually improves the output values \hat{x}ₜ (see FIG. 1), so as to gradually minimize the loss. Once the training S10 has completed and the neural parameters are stored in the IMC units 1, the neural processing apparatus 20 may execute S23-S27 the ANN model 100 for inference purposes, i.e., based on new (i.e., previously unseen) input data. The ANN is executed by performing S23 VMM operations involving the IMC units 1, which produce respective sets of output analog signals. Such output analog signals are converted into digital output values, which are themselves processed S26 to obtain activation values by applying activation functions. The digital output values can be processed S26 by a conventional processor 2, 3, outside of the crossbar arrays. In variants, they are processed by a near-memory processing unit 18, connected to the readout circuitry 16, as assumed in FIG. 2. The improvements obtained in respect of the distributions of output signals carry over from one layer to the next.

To summarize, the present methods revolve around training an ANN model with a dual objective, so as to enforce a certain property on the distribution of the activation values obtained by each layer (i.e., at least one neural layer of the ANN). The ANN parameters obtained are then stored in IMC units 1 of a neural processing apparatus 20 for it to perform S20 inferences. The dual objective controllably modifies the distribution of the analog signals obtained according to VMM operations performed by the IMC units 1, something that can be leveraged to improve the signal strength, and therefore the signal-to-noise ratio and, ultimately, the performance of the neural processing apparatus 20.

A preferred flow of operations is shown in FIG. 5, where high-level steps S10 and S20 generally refer to the training and inferencing phases. The training algorithm accesses S11 training examples from a training dataset 50. The forward pass of the training algorithm (a backpropagation algorithm in this example) computes S12 neural outputs. I.e., each layer takes input values, and computes and forwards output (activation) values to the next layer, so as to obtain neural outputs, i.e., the overall outputs of the ANN. The ANN parameters (including synaptic weights) are then updated S14 during the backward pass, based on the primary objective and the auxiliary objective of the training. I.e., such objectives are captured as a dual loss function, which includes several contributions, as explained above. The algorithm compares the current ANN outputs to the reference values (i.e., the labels) and then computes gradients, which tell how to update S14 the ANN parameters. This procedure is iterated (S15: No), as many times as necessary until a termination condition for the training objective is met. If so (S15: Yes), the training algorithm returns S16 the last neural parameters obtained S14. The “trained model” 53 corresponds to the ANN model as parameterized with the last neural parameters obtained.

From this point on, the inference phase S20 can start. This first requires to store S21 the trained neural parameters (starting with synaptic weights) across the crossbar arrays 15. Test data 54 are accessed by the apparatus 20 at step S22. At step S23, an input unit 11 applies input signals capturing input values of the test data (one input sample at a time) to a first crossbar array 15 for it to perform S23 VMM operations and produce analog output signals. Such signals are read out S24 by a readout circuitry 16, converted to digital signals (analog-to-digital conversion, or ADC), and passed S26 to a processing unit 2, 3, 18 for it to compute activation values. This processing unit then passes S27 the activation values to the next crossbar array 15 (corresponding to the next layer). Such the activation values will be converted to INT8 values, with a view to generating S23 further input values for the next layer. This procedure repeats (S25: No) for each layer (and thus each crossbar array 15), until the last layer (S25: Yes). The outputs of the last crossbar array are then processed S26 (i.e., by some classification or prediction layers) and a result is returned.

As noted earlier, the target distribution (or property) enforced on the activation values of each layer can be devised so as to increase the information entropy of the actual distribution of the activation values. This, in turn, increases the information entropy of the distribution of the analog output signals produced S23 by the IMC units upon performing VMM operations, as seen by comparing FIGS. 3 and 4. The first distribution on top of FIGS. 3 and 4 is the distribution of the activation values produced by a given layer. The middle distribution (second distribution in FIGS. 3 and 4) is a distribution of the same values after conversion to INT8 values, with a view to subsequently generating analog signals. Note, analog VMMs require parallel application of differently weighted input pulses to the crossbar arrays. In conventional PWM, the magnitudes of the INT8 input values are used to scale the width of the different read pulses that are applied on the source lines of the crossbar arrays. The bottom distribution (last distribution in FIGS. 3 and 4) is an aggregated distribution of the magnitudes (intensities) of all of the analog output signals produced in output of the output lines. More precisely, multiple VMMs were performed based on multiple INT8 vectors; the readout signals (i.e., the results of the VMMs, corresponding to output vectors) were then converted to digital values, which were then flattened into one long vector and plotted as a histogram.

Referring back to FIGS. 1 and 2, another aspect of the present disclosure is now described, which concerns an information processing system 10. The system 10 comprises processing devices 2, 3, 19, which are configured to train an ANN model 100, for the model 100 to learn its parameters (starting with synaptic weight values) in accordance with a dual objective, as explained earlier in reference to the present methods. I.e., the ANN model 100 comprises at least two neural layers 111-113, i.e., a first layer 111 and a second layer 112. The dual objective includes, on the one hand, a primary optimization objective 51 for the ANN model 100 and, on the other hand, an auxiliary objective 52, the latter meant to enforce a target distribution property on activation values produced by the first neural layer 111.

The system 10 further includes a neural processing apparatus 20, which includes at least two IMC units 1, i.e., a first IMC unit 1.1 and a second IMC unit 1.2. Each of the IMC units 1 is designed to perform VMM operations, to produce analog output signals, in operation. In particular, the second IMC unit 1.2 is designed to perform VMM operations based on analog input signals generated from activation values produced by the first neural layer 111, in operation. The processing devices 2, 3, 19 are otherwise operatively connected to the neural processing apparatus 20 to cause to store the synaptic weight values into the IMC units 1, to notably map the first neural layer 111 and the second neural layer 112 onto the first IMC unit 1.1 and the second IMC unit 1.2, respectively.

The above architecture can be extended to any number of layers and IMC units. I.e., the neural processing apparatus 20 may generally comprise L units 1 (L≥2), where the IMC units 1 are cascaded to form a chain of L units. That is, one unit 1 branches into another unit, either directly or indirectly, i.e., through an external processing unit 2, 3. Consistently, the ANN model 100 comprises L neural layers. In that case, the processing devices 2, 3 are operatively connected to the neural processing apparatus 20 to cause to store the synaptic weight values of the parameters learned in the L units 1, so as to effectively map the L neural layers onto the L units 1, in operation. In operation, the auxiliary objective 52 causes to enforce target distribution properties on L−1 sets of activation values as respectively produced by the first L−1 layers. As a result, the last L−1 IMC units of the chain perform VMM operations based on L−1 sets of analog input signals generated from the L−1 sets of activation values obtained from the first L−1 neural layers of the chain, respectively. The ANN model 100 includes only three internal (hidden) layers 111, 112, 113, for simplicity. The layers 111, 112, 113 are mapped onto three respective IMC units 1.1, 1.2, 1.3.

The processing devices 2, 3, 19 may further be operatively connected to the neural processing apparatus 20 to further cause to execute the ANN model 100 for inference purposes, by performing VMM operations involving the IMC units 1. And, as explained earlier, the target distribution property can be devised so that enforcing the target distribution property causes to increase an information entropy of a distribution of the set of activation values produced by one or more of the neural layers, which, in turn, increases the information entropy of a distribution of analog output signals produced by the IMC units (starting from the second IMC unit) upon performing the VMM operations.

Note, the processing devices 2, 3, 19 may notably include a conventional computer 2 and/or a computerized system 3 (for example a workstation or a computer configured as a server, as assumed in FIG. 1). The processing devices 2, 3 are, or form part of, conventional computerized means that are used to train the ANN model 100. In addition, the system 1 may include processing devices 19 that are configured as near-memory processing units in the IMC units 1. Such processing devices 19 are located close to each crossbar array 15 and can process output values (after ADC) to produce activation values, so as to pass the processed values more efficiently to the next IMC unit 1, as assumed in FIG. 2.

FIG. 2 schematically represents selected components of an IMC unit 1, which notably includes a crossbar array structure 15 (also referred to as a ‘crossbar array’ in this document), as well as a programming unit 19 to program memory elements of the crossbar array structure 15, as in embodiments.

The IMC device 1 includes N input lines 151 and M output lines 152, which lines are interconnected at cross-points (i.e., junctions). The cross-points accordingly define N×M cells 154, also called unit cells. The input and output lines are interconnected via memory systems 156. In principle, at least two input lines and two output lines are needed to define an array (i.e., N≥2 and M≥2). In practice, however, the number of input lines 151 and output lines 152 will typically be on the order of several hundreds to thousands of lines. For example, arrays of 256×256, 512×512, or 1024×1024 may be contemplated, although N need not be necessarily equal to M. The IMC device 1 shown in FIG. 2 is meant to form part of a neural processing apparatus 20 as shown in FIG. 1. Each IMC unit 1 may implement up to M neurons at a time. The number of neurons per layer may thus be equal to 256, 512, or 1024, for example.

The memory elements are analog memory devices, which can notably be phase-change memory (PCM) devices, resistive random-access memory (RRAM) devices, or flash memory cell devices. Using such devices, a weight value is mapped over a conductance range of a memory element, as opposed to multiple binary devices representing different weight bits in digital storage. Preferred embodiments rely on PCM devices.

In embodiments, each memory system 156 includes a single memory element. In variants, each memory system 156 may include a group of K memory elements (not shown), which are arranged in parallel in this group. Each cell may contain two groups of K memory elements each. Various connection schemes can be contemplated. Preferably, each input (respectively output) line typically subdivides into K or 2 K conductors, so as to adequately connect to (respectively from) respective memory elements of each cell. So, each input (or output) line typically includes several, parallel electrical conductors. For now, assume that each cell contains a group of K memory elements, such that each cell 154 includes K memory elements.

In embodiments, each cell is programmed according to a target conductance value corresponding to a target weight value to be stored in said each cell. Each cell is programmed, using the programming means 19, by first setting the K memory elements to a SET state. To that aim, a SET signal is applied to the K memory elements of each cell. The K conductance values of the K memory elements (now in a SET state) are subsequently read, with a view to adjusting the electrical conductance of the cell. I.e., the conductance value of at least one of the K memory elements is adjusted based on the K conductance values read and the target conductance value. This can be performed so as to match a summed conductance of the K memory elements of the cell with the target conductance value, while maximizing a number of the K memory elements that are either in their SET state or in a RESET state of zero conductance nominal value, such that at most one of the K memory elements is neither in a SET state nor in a RESET state. Doing so makes it possible to reduce inaccuracies due to intermediate conductance states across the array. This, in turn, leads to significant reduction in programming errors and increases the computational precision.

Besides the crossbar array structure 15, the IMC device 1 may include a programming unit 19, which is connected to the IMC device 1, as shown in FIG. 2. The programming unit 19 may notably be connected to input lines 151 of the IMC device 1. The programming unit 19, however, is normally independent from the input unit 11, which is used to apply signals to the input lines 151, to operate the IMC device 1. The programming unit 19 is generally configured to program each cell 154 of the device 1 in accordance with principles described above. In particular, the programming unit 19 is designed so as to be able to set, reset, and adjust conductance values of memory elements of each cell 154, as necessary to match a summed conductance of the memory elements of each cell with a target conductance value. As explained above, the programming unit 19 may do so by maximizing a number of the memory elements that are either in a SET state or in a RESET state (of zero conductance nominal value), under the constraint that at most one memory elements is neither in a SET state nor in a RESET state.

In embodiments, the memory system 156 of each cell 154 of the IMC device 1 includes two groups of K memory elements, where the two groups are in a differential configuration. In that case, the programming unit 19 must further be able to select a given group in accordance with the sign of the target weight to be stored in each cell 154.

For instance, the unit 19 may be adapted to adjust conductance values of the memory elements by applying suitable voltage signals across the input lines or the output lines, respectively 151 of the IMC device 1. In variants, the programming unit 19 may connect to the memory elements via independent connectors. Note, the device 1 typically includes readout circuitry 16 connected in output of the output lines 152. The programming unit 19 may thus be connected to the readout circuitry 16, in output thereof, so as to be able to adjust conductance values of the memory elements in accordance with a single-device programming method as discussed above. Moreover, the system 1 may further include a processing unit 18, connected in output of the IMC device 1 i.e., in output of the readout circuitry 16. This processing unit 18 is preferably arranged as a near-memory processing unit. In that case, the programming unit 19 may advantageously be connected in output of the near-memory processing unit 18, to allow a closed-loop programming of the crossbar array structure 15, as assumed in FIG. 2. In variants, the processing unit 18 and the programming unit 19 are implemented as one and a same unit. The programming unit 19 may further include an input/output (I/O) controller and be configured to communicate with external devices or computers 2, 3, as illustrated in FIG. 1.

Once the weights have been programmed across the crossbar array 15, vector components can be injected into the crossbar array structure 15. More precisely, signals encoding a vector of N components (i.e., an N-vector) can be applied to the N input lines 151 of the crossbar array structure 15, via the input unit 11, e.g., to cause the crossbar array structure 15 to perform multiply-accumulate (MAC) operations based on the N-vector and the N×M weights stored in the device 15. The MAC operations result in that the values encoded by the signals fed into the N input lines are respectively multiplied by the weight values.

Such MAC operations are performed as part of executing the ANN 100. As a single crossbar array structure 15 typically implements one neural layer at a time, several IMC units are cascaded. The neural layer implemented by a crossbar array structure 15 can be a full layer of the ANN 100 or only a portion of this layer. The optimal mapping of operations can be initially determined by an external processing unit 2, 3, i.e., a unit distinct from the core compute array 15. However, use can be made of a processing unit 18 that is preferably co-integrated with the core IMC array 15 in the system 1, as assumed in FIG. 2, to compute activation values according to given activation functions. The external processing unit 2, 3 can be used to determine the computation strategy (i.e., input vectors and block matrices, and associate them), in addition to the training S10. The corresponding matrix weight values can then be passed to the programming unit 19 for it to suitably program the cells of the crossbar array structure 15. In practice, the programming unit 19 may include a programming controller. Like the input unit 11, the programming unit 19 may include, or be connected to, a signal generator to apply pulses in accordance with the programming controller.

The system 10 shown in FIG. 1 includes several IMC devices 1, which are connected to each other to form a neural apparatus 20. Each IMC device 1 is preferably fabricated as an integrated device. In particular, the crossbar array structure 15 IMC device 1, the processing unit 18, and the programming unit 19, may all be co-integrated in a same chip, as assumed in FIG. 1. The IMC device 1 may thus consist of a single device (e.g., a single chip), co-integrating all the required components. The apparatus 10 itself can be fabricated as a single device. The apparatus 10 may be used in a special-purpose infrastructure or network, e.g., to serve multiple, concurrent client requests from users 4, as assumed in FIG. 1. The overall system 10 may for instance be configured as a composable disaggregated infrastructure, which may further include other hardware acceleration devices, e.g., application-specific integrated circuits (ASICs) and/or field-programmable gate arrays (FPGAs).

A final aspect of the present disclosure is now described in reference to FIG. 7. This aspect concerns a computer program product for controlling a precision of a neural processing apparatus 20 as described earlier. The computer program product comprises a computer readable storage medium having program instructions embodied therewith, where the program instructions are executable by processing devices 2, 3 connected to the neural processing apparatus 20 to cause such processing devices 2, 3 to train an ANN model 100, for the model to learn its parameters in accordance with a dual objective, as explained earlier in reference to the present methods. IN addition, such instructions will cause to instruct to store the synaptic weight values of the parameters learned in the IMC units 1 to respectively map neural layers of the ANN model 100 onto the IMC units 1. Each of the processing devices 2, 3 may form part of a computer 701 as shown in FIG. 7.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as code 200 for training the ANN model 100 and interfacing with the neural processing apparatus 20 to cause to store synaptic weight values in the IMC units 1. In addition to block 200, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 200, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located off chip. In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as the inventive methods). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 200 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701) and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 7$$140 is the collection of computer software, hardware, and firmware that allows public cloud 705 to communicate through WAN 702.

Some further explanation of virtualized computing environments (VCEs) will now be provided. VCEs can be stored as images. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

While the present disclosure has been described with reference to a limited number of embodiments, variants and the accompanying drawings, it will be understood by those skilled in the art that various changes may be made, and equivalents may be substituted without departing from the scope of the present disclosure. In particular, a feature (device-like or method-like) recited in a given embodiment, variant or shown in a drawing may be combined with or replace another feature in another embodiment, variant or drawing, without departing from the scope of the present disclosure. Various combinations of the features described in respect of any of the above embodiments or variants may accordingly be contemplated, that remain within the scope of the appended claims. In addition, many minor modifications may be made to adapt a particular situation or material to the teachings of the present disclosure without departing from its scope. Therefore, it is intended that the present disclosure is not limited to the particular embodiments disclosed, but that the present disclosure will include all embodiments falling within the scope of the appended claims. In addition, many other variants than explicitly touched above can be contemplated.

What is claimed is:

1. A method of controlling a precision of a neural processing apparatus comprising two in-memory compute (IMC) units, wherein the IMC units include a first IMC unit and a second IMC unit, each designed to perform vector-matrix multiplication (VMM) operations, to produce analog output signals, the method comprising:
training an artificial neural network (ANN) model to learn its parameters in accordance with a dual objective, wherein the ANN model comprises two neural layers including a first neural layer and a second neural layer, the parameters including synaptic weight values; and
storing the synaptic weight values of the parameters learned in the two IMC units to respectively map the first neural layer and the second neural layer onto the first IMC unit and the second IMC unit, wherein:
the second IMC unit is designed to perform VMM operations based on analog input signals generated from activation values produced by the first neural layer, and
the dual objective includes a primary optimization objective for training the ANN model and an auxiliary objective enforcing a target distribution property on activation values produced by the first neural layer.

2. The method according to claim 1, wherein enforcing the target distribution property causes to increase an information entropy of the distribution of activation values across a range of values spanned by the activation values.

3. The method according to claim 1, wherein the auxiliary objective enforces said target distribution property by enforcing a target distribution on the set of activation values.

4. The method according to claim 3, wherein training the ANN model comprises minimizing, as per the auxiliary objective, a distance between the distribution of the activation values and the target distribution to an extent permitted by the primary optimization objective for training the ANN model, in accordance with said dual objective.

5. The method according to claim 4, wherein training the ANN model comprises optimizing the ANN model against a loss function capturing the dual objective, wherein the loss function can be decomposed as a sum of two contributions, including:
a first contribution reflecting the primary optimization objective; and
a second contribution reflecting the auxiliary objective, the second contribution depending on the distance between the distribution of the set of activation values and the target distribution.

6. The method according to claim 5, wherein, at training the ANN model, the second contribution is implemented by a regularizer added to the loss function.

7. The method according to claim 5, wherein the ANN model is iteratively trained, and wherein training the model comprises:
approximating, after a forward pass, a current distribution of said set of activation values by a kernel density function, whereby said distance is measured as a distance between the kernel density function and the target distribution; and
updating, during a backward pass, said parameters with a view to decreasing said loss function, this causing to decrease said distance.

8. The method according to claim 7, wherein:
the kernel density function is differentiable with respect to variables corresponding said activation values, whereby the distance between the kernel density function and the target distribution is differentiable with respect to said parameters, and
the ANN model is trained in accordance with a backpropagation algorithm using partial derivatives of the loss function with respect to said parameters.

9. The method according to claim 7, wherein:
training the ANN model further comprises generating evenly spaced bins spanning said range of values, with a view to measuring said distance thanks to a distance function, and
the distance is evaluated as a sum of values taken by the distance function over said bins.

10. The method according to claim 9, wherein said distance is measured as a Kullback-Leibler divergence between the kernel density function and the target distribution.

11. The method according to claim 9, wherein said distance is measured as an information entropy of the kernel density function, the information entropy computed as an expected value of a logarithm of the kernel density function computed over said bins.

12. The method according to claim 1, further comprising:
executing the ANN model for inference purposes by:
performing VMM operations involving the two IMC units to obtain respective sets of output analog signals,
converting the output analog signals into digital output values, and
processing such digital output values to obtain activation values.

13. The method according to claim 12, wherein
the target distribution property is devised to cause to increases of information entropy of said distribution of activation values across a range of values spanned by the activation values upon enforcing the target distribution property, so as to increase an information entropy of a distribution of analog output signals produced by the second IMC unit upon performing said VMM operations.

14. The method according to claim 13, wherein the target distribution property is devised to increase a signal-to-noise ratio of said analog output signals.

15. The method according to claim 13, wherein the target distribution property is a uniform distribution.

16. The method according to claim 1, wherein:
the neural processing apparatus comprises L IMC units, L>2, where the IMC units are cascaded,
the ANN model comprises L neural layers,
the synaptic weight values of the parameters learned are stored in the L IMC units, so as to effectively map the L neural layers onto the L IMC units,
the auxiliary objective enforces target distribution properties on L−1 sets of activation values respectively produced by the first L−1 layers, so as for the last L−1 IMC units of the L IMC units to perform VMM operations based on L−1 sets of analog input signals generated from the L−1 sets of activation values obtained from the first L−1 neural layers, respectively.

17. An information processing system comprising:
one or more processing devices configured to train an artificial neural network (ANN) model to learn its parameters in accordance with a dual objective, wherein:
the ANN model comprises two neural layers, these including a first neural layer and a second neural layer,
the parameters include synaptic weight values, and
the dual objective includes a primary optimization objective for training the ANN model and an auxiliary objective enforcing a target distribution property on activation values produced by the first neural layer, and
a neural processing apparatus including two in-memory compute (IMC) units including a first IMC unit and a second IMC unit, wherein
each of the IMC units is designed to perform vector-matrix multiplication (VMM) operations to produce analog output signals,
the second IMC unit is designed to perform VMM operations based on analog input signals generated from activation values produced by the first neural layer, in operation, and
the processing devices are operatively connected to the neural processing apparatus to cause to store the synaptic weight values in the two IMC units to respectively map the first neural layer and the second neural layer onto the first IMC unit and the second IMC unit, in operation.

18. The information processing system according to claim 17, wherein:
the processing devices are operatively connected to the neural processing apparatus to further cause to execute the ANN model for inference purposes, by performing VMM operations involving the two IMC units, and
the target distribution property is devised so that to enforcing the target distribution property causes to increase an information entropy of a distribution of the set of activation values produced by the first neural layer and, in turn, increase an information entropy of a distribution of analog output signals produced by the second IMC unit upon performing said VMM operations.

19. The information processing system according to claim 17, wherein:
the neural processing apparatus comprises L IMC units, L>2, where the IMC units are cascaded,
the ANN model comprises L neural layers,
the processing devices are operatively connected to the neural processing apparatus to cause to store the synaptic weight values of the parameters learned in the L IMC units, so as to effectively map the L neural layers onto the L IMC units, in operation, and
the auxiliary objective causes, in operation, to enforce target distribution properties on L−1 sets of activation values respectively produced by the first L−1 layers, so as for the last L−1 IMC units of the L IMC units to perform VMM operations based on L−1 sets of analog input signals generated from the L−1 sets of activation values obtained from the first L−1 neural layers, respectively.

20. A computer program product for controlling a precision of a neural processing apparatus comprising two analog, in-memory compute units, or IMC units, these including a first IMC unit and a second IMC unit, the computer program product comprising a computer readable storage medium having program instructions embodied therewith, the program instructions executable by a processing device connected to the neural processing apparatus to cause the processing device to:
train an artificial neural network model, or ANN model, for the model to learn its parameters in accordance with a dual objective, wherein the ANN model comprises two neural layers, these including a first neural layer connected to a second neural layer, and the parameters include synaptic weight values; and
instruct to store the synaptic weight values of the parameters learned in the two IMC units to respectively map the first neural layer and the second neural layer onto the first IMC unit and the second IMC unit, wherein the dual objective includes a primary optimization objective for training the ANN model and an auxiliary objective enforcing a target distribution property on activation values produced by the first neural layer.
